(19) United States
(12) Patent Application Publication
(10) Pub. No.: US 2017/0151827 A1
(43) Pub. Date: Jun. 1, 2017

(54) REWRITABLE TABLET BOOK AND METHOD OF USE

(71) Applicant: BETABOOK LLC, Bethesda, MD (US)

(72) Inventors: Gabriel Shalom, Portland, OR (US); Patrizia Kommerell, Portland, OR (US); Jay Cousins, Scarborough (UK)

(21) Appl. No.: 15/322,821

(22) PCT Filed: Oct. 2, 2015
(86) PCT No.: PCT/US2015/053627

§ 371 Date: Dec. 29, 2016

Related U.S. Application Data
(60) Provisional application No. 62/059,227, filed on Oct. 3, 2014.

(51) Int. Cl. B43L 1/00; B43L 21/00

(52) U.S. Cl. CPC B43L 1/00; B43L 21/00

(57) ABSTRACT

A rewritable tablet book includes a front cover, a back cover, and a spine connecting the back cover to the front cover. The rewritable tablet book includes a rewritable surface that extends across an inside surface of the front cover, the spine, and the back cover. The rewritable tablet book also includes a fastener. The fastener joins the front cover to the back cover in a closed position to hold a marker in a hollow region defined by the rewritable surface and the spine. The marker is locked in the hollow region.

### RELATED APPLICATIONS

This application claims the benefit under 35 U.S.C. §119(e) of U.S. Provisional Application Ser. No. 62/059,227, filed on Oct. 3, 2014, which is incorporated herein by reference in its entirety.

### BACKGROUND OF THE INVENTION

A whiteboard (aka, markerboard, dry-erase board, dry-wipe board, or pen-board) is typically utilized in an office, meeting room, school classroom, or other workroom. The whiteboard is usually mounted on the wall for use in front of a group of people. The whiteboard generally includes a rewritable surface. For example, this rewritable surface is a whiteboard sheet having a glossy surface (typically colored white) for use with nonpermanent ink. The nonpermanent ink can be erased with minimal effort by applying light friction with a cloth.

Whiteboards have been used in small rewritable tablets providing portability. Rewritable tablets can be mounted easily on the outside of a door or mounted next to a desk (e.g., on the wall of a cubicle).

Recently, rewritable tablets have been further used in rewritable tablet books. Rewritable tablet books include multiple rewritable surfaces in the form of multiple rewritable sheets (e.g., whiteboard sheets) bound together within a front cover, back cover, and spine. Similar to pages in a book or notebook, the rewritable sheets are typically bound together using binding (e.g., coil binding or comb binding) to form the rewritable tablet book. Some rewritable tablet books additionally include a sleeve or pocket for storing an eraser and/or marker for later use.

### SUMMARY OF THE INVENTION

Current rewritable tablet books have a number of problems. For example, rewritable tablet books that have multiple rewritable sheets are bulky and cumbersome. Although some rewritable tablet books have sleeves or pockets, the sleeves or pockets have a short lifetime due to wear and tear. Thus, there is a need for a compact rewritable tablet book that is portable and can store at least a marker without requiring the additional sleeve or pocket.

The present invention is directed to a rewritable tablet book having a spine that can function with a rewritable surface to hold a marker within a hollow region. The present invention is directed toward further solutions to address this need, in addition to having other desirable characteristics.

In general, according to one aspect, the invention features a rewritable tablet book including a front cover, a back cover, and a spine for connecting the back cover to the front cover. The rewritable tablet book includes a rewritable surface extending across an inside surface of the front cover, the spine, and the back cover. The rewritable tablet book also includes a fastener. The fastener joins the front cover to the back cover in a closed position to hold a marker in a hollow region defined by the rewritable surface and the spine.

In embodiments, the spine can be constructed from an elastic material such as rubber.

In embodiments, the fastener is a closure band, a clip, a magnet, a string tie, a snap, a clasp, a rivet, or a pin for joining or disjoining the front cover to or from the back cover.

In embodiments, the hollow region has a diameter range between about 12 millimeters and about 14 millimeters in the closed position. The hollow region can preferably hold the marker wrapped in an eraser cloth.

The front cover and back cover can be constructed from a cardboard material. The front cover and back cover preferably each have a thickness range between about 2 millimeters and about 5 millimeters.

The rewritable surface can be constructed of a plastic material. In example embodiments, the rewritable surface is opaque or transparent.

In at least one embodiment, the front cover, the back cover, and the spine can be constructed from a unitary sheet.

In embodiments, the spine includes at least two different thicknesses. For example, the spine includes a distal region extending from an edge of the spine to a terminus point of the distal region. The distal region has a first thickness. A transitional region extends from the terminus point of the distal region. A central region extends from the transitional region and the central region has a second thickness. The spine thickness of the transitional region decreases from the terminus point of the distal region to the central region such that the first thickness is greater than the second thickness.

In general, according to another aspect, the invention features a rewritable tablet book kit having a front cover, a back cover, and a spine connecting the back cover to the front cover. The kit also includes a rewritable surface extending across an inside surface of the front cover, the spine, and the back cover. The rewritable tablet book kit further includes a fastener. The kit includes a marker for writing on the rewritable surface. The fastener joins the front cover to the back cover in a closed position to hold the marker in a hollow region defined by the rewritable surface and the spine.

The kit can further include an eraser cloth for erasing writing from the rewritable surface. The eraser cloth is wrapped around the marker and held in the hollow region defined by the rewritable surface and the spine in the closed position. The eraser cloth can be constructed from polar fleece, cotton, wool, polyester, or microfiber.

In embodiments, the marker has a diameter range between about 13 millimeters and about 17 millimeters.

In general, according to another aspect, the invention features a method for storing a marker in a rewritable tablet book. The rewritable tablet book has a front cover, a back cover, a spine, and a rewritable surface extending across an inside surface of the front cover, the spine, and the back cover. A fastener joins the front cover to the back cover in a closed position. The rewritable surface holds a marker in a hollow region defined by the rewritable surface and the spine in the closed position.

The eraser cloth can be wrapped around the marker. The rewritable surface holds the marker wrapped in the eraser cloth in the hollow region defined by the rewritable surface and the spine in the closed position.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a front perspective view of a rewritable tablet book in a closed position;

FIG. 2 is a back perspective view of the rewritable tablet book in the closed position;

FIG. 3A is a cross-sectional view of the rewritable tablet book in the closed position gripping a marker according to an embodiment of the present invention;

FIG. 3B is a cross-sectional view of the rewritable tablet book in the closed position gripping the marker wrapped in an eraser cloth according to another embodiment of the present invention;

FIG. 3C is a cross-sectional view of the rewritable tablet book in the closed position gripping o-rings of the marker according to another embodiment of the present invention;

FIG. 4 is an overhead view of the rewritable tablet book in an open position; and

FIG. 5 is an overhead view of the eraser cloth, the marker, and the marker having o-rings.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features and/or components, but do not preclude the presence or addition of one or more other features and/or components. Further, it will be understood that when an element, including component or subsystem, is referred to and/or shown as being connected or coupled to another element, it can be directly connected or coupled to the other element or intervening elements may be present.

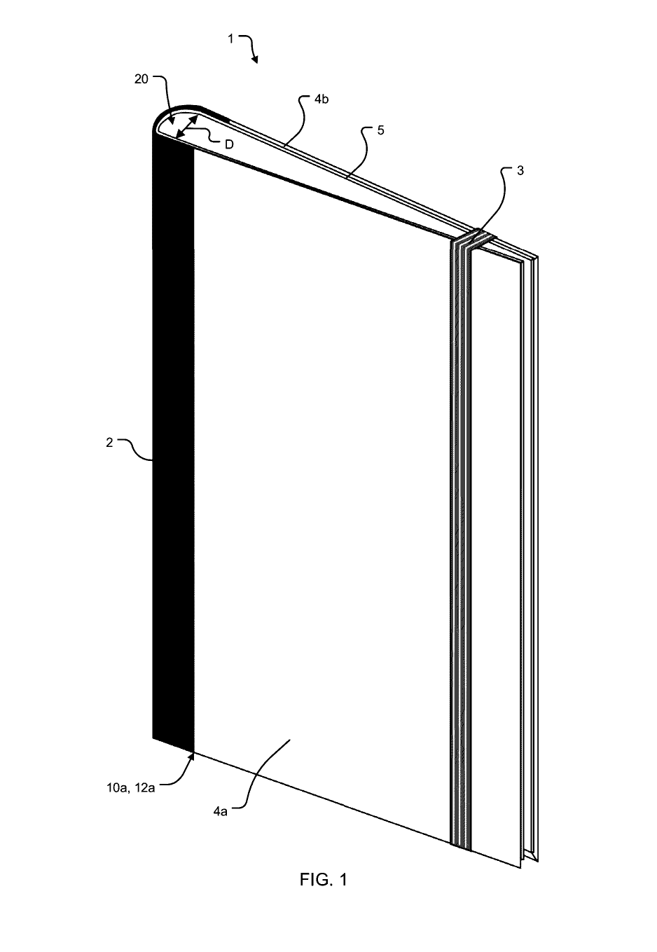

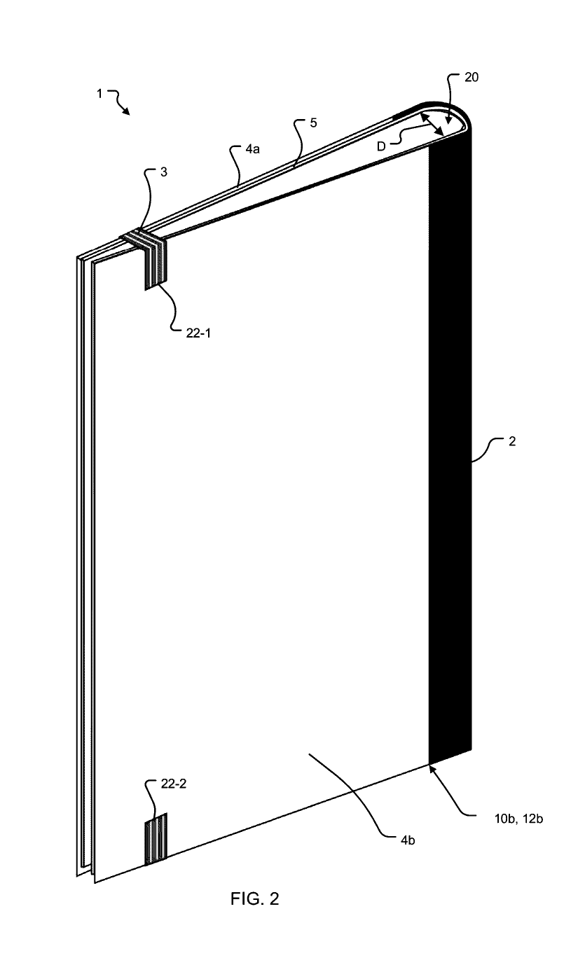

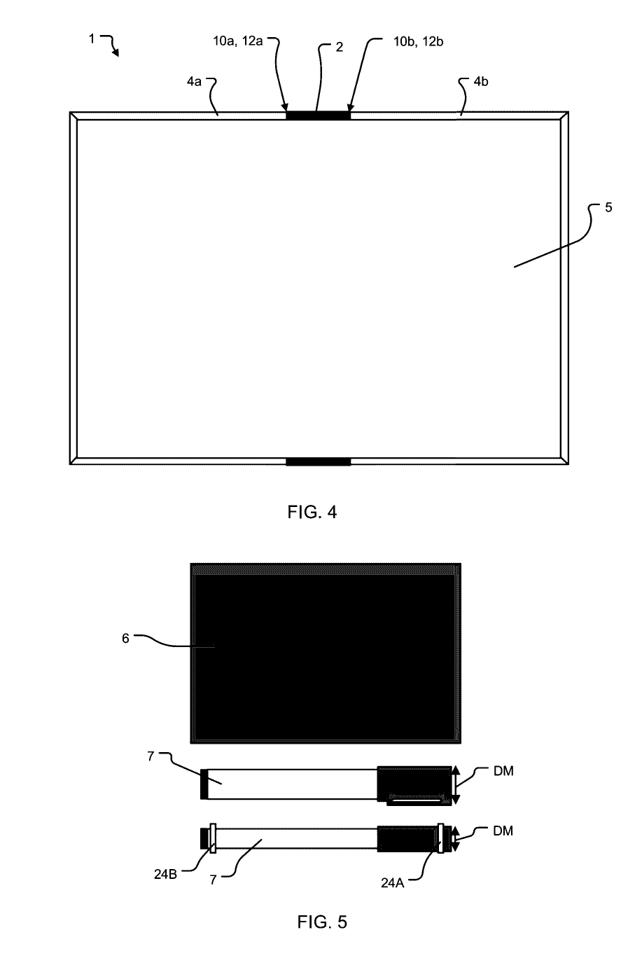

FIGS. 1-4 illustrate a rewritable tablet book 1 constructed according to the principles of the present invention. When not in use, the rewritable tablet book 1 is typically folded into a closed position as shown in FIGS. 1-3C. When in use, the rewritable tablet book 1 is in an open position as shown in FIG. 4.

The rewritable tablet book 1 includes a front cover 4a and a back cover 4b. The covers 4a, 4b provide a protective covering. In one example, the covers 4a, 4b can be constructed from a rigid material such as pasteboard or stiff paper (e.g., cardboard). In another example, the covers 4a, 4b can be constructed from cardboard that is covered with a paper material such as cover stock paper. The covers 4a, 4b can be constructed from other materials such as wood, high density fiber board, rubber, plastic, metal, or the like as appreciated by one of skill in the art. The thickness of each cover 4a, 4b usually has a range between about 2 millimeters and about 5 millimeters.

As illustrated in FIGS. 1-4, each cover 4a, 4b has a generally rectangular shape. Thus, each cover 4a, 4b has at least two longitudinal edges 12a, 12b. For example, the front cover 4a has longitudinal edges 12a, 12b and the back cover 4b has longitudinal edges 12a, 12b.

The rewritable tablet book 1 includes a spine 2. The spine 2 has a first longitudinal edge 10a and a second longitudinal edge 10b opposite from the first longitudinal edge 10a. The spine 2 is constructed from a material having the properties of being flexible, elastic, and resilient. In particular, the spine 2 is constructed from a material having sufficient radial flexibility, elasticity, and resiliency to enable the spine 2 to form a hollow region 20 that provides an interference compression fit with a marker 7, when closed. Further, the spine 2 can be constructed of a material having the necessary frictional properties (i.e., coefficient of friction) such that the spine 2 grips the surface of a table top to prevent the rewritable tablet book 1 from sliding on the surface. Preferably, the spine 2 is constructed from a rubber material having the above described properties. For example, the rubber material is synthetic rubber such as ethylene propylene diene monomer (EPDM) or neoprene. The spine 2 has a general thickness range between about 0.5 millimeter and about 3.5 millimeters, in some examples. Preferably, the spine 2 has a thickness range between about 0.5 millimeter and about 1 millimeter. In one example, the spine 2 has a thickness of about 0.6 millimeter.

The front cover 4a and back cover 4b are bound respectively to opposing sides of the spine 2. For example, at least one longitudinal edge 12a of the front cover 4a is mounted to the first longitudinal edge 10a of the spine 2. In addition, at least one longitudinal edge 12b of the back cover 4b (opposite side of the back cover 4b with respect to the mounted longitudinal edge 12a of the front cover 4a) is mounted to the second longitudinal edge 10b of the spine 2. In this example, the covers 4a, 4b are bound to the spine 2 using adhesive such as glue or a fusing process. Alternatively, other similar book binding processes may be used as appreciated by one of skill in the art in order to bind the front cover 4a and back cover 4b to the opposing sides of the spine 2 to form the rewritable tablet book 1. The spine 2, coupled between the front cover 4a and back cover 4b, provides either an open position or a closed position.

The rewritable tablet book 1 includes a rewritable sheet having a rewritable surface 5. In one example, the rewritable surface 5 is constructed as a solitary member. Alternatively the rewritable surface 5 is constructed as two or more members. The rewritable surface 5 is made from a material or combination of materials providing a surface capable of accepting writing. The rewritable surface 5 has a thickness range between about 0.2 millimeter and about 0.5 millimeter. A marker 7, such as a dry erase marker, can be used to provide writing to the rewritable surface 5.

In one example, the rewritable surface 5 includes a dry erase whiteboard material such that a user can write on the rewritable surface 5. This white board material is plastic such as polyethylene terephthalate (PET) material, polyvinyl chloride (PVC) material, and/or polypropylene material. In one example, the rewritable surface 5 is constructed from plastic that is coated to provide the writing surface. In particular, the plastic is sprayed or treated with a thin layer of chemical formula to form a coated surface on the plastic. The coated surface allows for receiving of writing from the marker 7 and erasing of writing by an eraser cloth 6.

The rewritable surface 5 can be constructed from other materials to provide a surface that accepts writing. In another example, the rewritable surface 5 is constructed from paper that is laminated. In other examples, the rewritable surface 5 is constructed from blackboard material (e.g., chalk board) or e-paper material (e.g., uses electronic marker with touchscreen computer). The rewritable surface 5 is constructed of other materials that provide the writing surface as appreciated by one of skill in the art.

The dimensions (width by length) of the rewritable surface 5 can vary. Example width by length dimensions include about 297 millimeters by about 420 millimeters (i.e., A3 size), about 210 millimeters by about 297 millimeters (i.e., A4 size), about 148 millimeters by about 210 millimeters (i.e., A5 size), or the like.

After the covers 4a, 4b are mounted to the spine 2, the rewritable surface 5 is mounted such that the rewritable surface 5 extends across an inside surface of the front cover 4a, the spine 2, and the back cover 4b. In particular, the rewritable surface 5 is preferably a unitary sheet that is mounted directly to an inside surface (i.e., surface facing inside rewritable tablet book 1) of the front cover 4a, back cover 4b, and spine 2. Alternatively, the rewritable surface 5 is comprised of two sheets. For example, a first sheet is mounted directly to an inside surface of the front cover 4a, a second sheet is mounted to the back cover 4b, and both sheets are mounted to the spine 2. In other examples, the rewritable surface 5 is constructed of more than two sheets as appreciated by one of skill in the art. The rewritable surface 5 can be mounted using an adhesive (e.g., glue). In one example, an adhesive layer is applied to the inside surface of the front cover 4a, back cover 4b, and spine 2. The rewritable surface 5 is laid flat onto this adhesive layer on the covers 4a, 4b and spine 2 to firm the rewritable tablet book 1.

When the rewritable tablet book 1 is closed (i.e., closed position), the spine 2 in combination with the rewritable surface 5 form a hollow region 20 for gripping the marker 7. In particular, the spine 2 engages the rewritable surface 5 such that the spine 2/rewritable surface 5 combination bend to form the hollow region 20 for gripping and fixing the marker 7 in place. The spine 2/rewritable surface 5 combination provides resilient and compressible characteristics. In particular, the spine 2/rewritable surface 5 combination has sufficient radial resiliency to provide the interference compression fit around the marker 7. This radial resiliency enables the hollow region 20 to expand slightly to fit around the marker 7 providing the interference compression fit. During this interaction, resilient and compressive forces are uniformly distributed along the marker 7. A coefficient of friction between the surface of the marker 7 and the rewritable surface 5 provides frictional forces that aid in forming the interference compression fit. These properties allow for the marker 7 to be retained within the hollow region 20 irrespective of an orientation of the rewritable book 1. Thus, the spine 2/rewritable surface 5 combination functions as a glove in holding the marker 7 in the hollow region 20 irrespective of the orientation of the rewritable tablet book 1. The spine 2 and rewritable surface 5 are constructed of preferred materials having sufficient flexible, elastic, resilient, and frictional properties to provide this desired interference compression fit with the marker 7.

The rewritable tablet book 1 includes a fastener 3 for maintaining the rewritable tablet book 1 in the closed position. In one example, as illustrated in FIGS. 1-3C, the fastener 3 is a closure band that wraps around the covers 4a, 4b to maintain the closed position. In this example, the fastener 3 (i.e., closure band) is constructed from an elastic-like material such as a thin elastic band. Two ends of the fastener 3 are affixed to the back cover 4b. For example, a first end 22-1 of the fastener 3 is affixed to a top section of the back cover 4b whereas a second end 22-2 of the fastener 3 is affixed to a lower section of the back cover 4b. In the illustrated example, the fastener 3 as a closure band joins the back cover 4b to the front cover 4a.

Alternatively, the fastener 3 can be in the form of a clip, magnet, string tie, snap, clasp, rivet, pin, or the like as appreciated by one of skill in the art for maintaining closure (i.e., closed position) of the rewritable tablet book 1.

In one implementation, the fastener 3 is a magnet embedded below the rewritable surface 5 to maintain closure. In such example, there are two fasteners 3 in the form of a first magnet and a second magnet. The first magnet is embedded in the rewritable surface 5 on the front cover side which binds to the second magnet embedded in the rewritable surface 5 on the back cover side to maintain closure of the rewritable tablet book 1.

In another implementation, the fastener 3 is a clip. In this implementation, there are two fasteners—male clip and female clip. The male clip is mounted to the re writable surface 5 on the front cover side and the female clip is mounted to the rewritable surface 5 on the back cover side. In the closed position, the male clip fits within the female clip. The clips join the front cover 4a to the back cover 4b in the closed position.

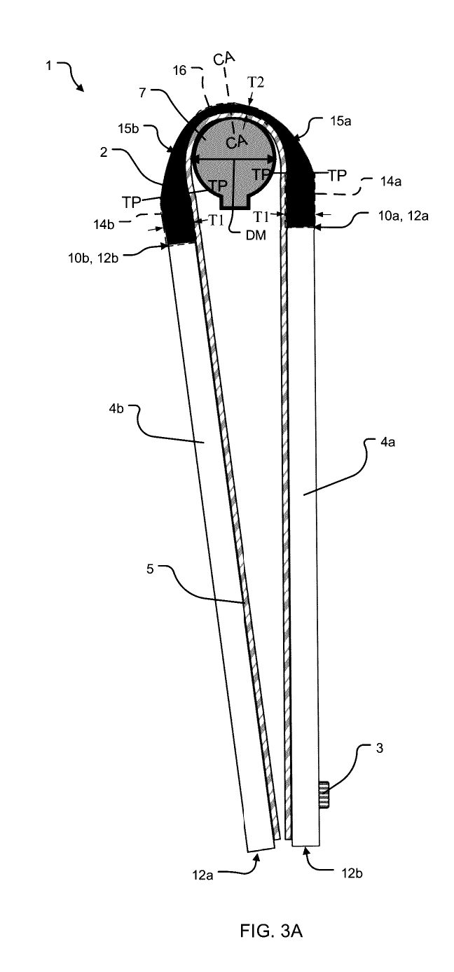

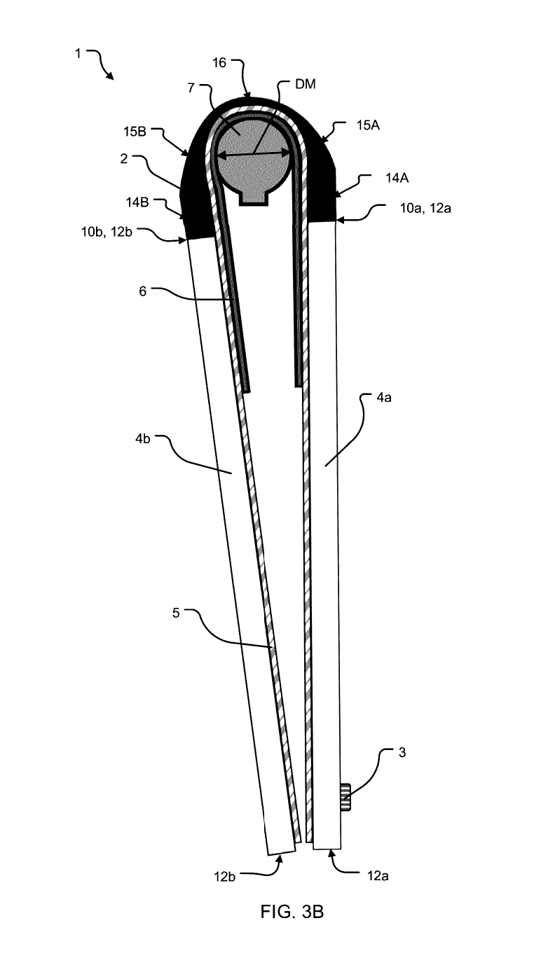

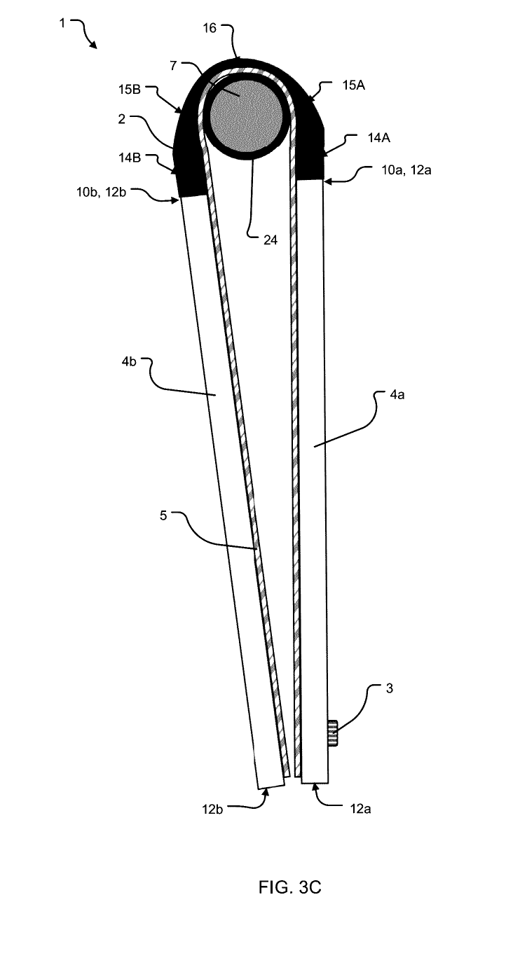

FIGS. 3A and 3B are cross-sectional views of the rewritable tablet book 1 in the closed position. In FIG. 3A, the rewritable tablet book 1 is configured to grip the marker 7 in the closed position. FIG. 3B illustrates the ability of the rewritable tablet book 1 to additionally grasp the eraser cloth 6 along with the marker 7 in the closed position.

As illustrated in FIG. 3A, the rewritable tablet book's components provide the ability for the rewritable tablet book 1 to grip the marker 7 in the closed position. In particular, in the closed position, the spine 2 has a generally curved or rounded shape forming the hollow region 20 with the rewritable surface 5 at the base of the spine 2. This hollow region 20 provides an area where the marker 7 can tightly fit and be gripped by the spine 2/rewritable surface 5 combination in the closed position. The front cover 4a, back cover 4b, and fastener 3 provide additional forces for closing the rewritable tablet book 1 such that the marker 7 is gripped and fixed in place within the hollow region 20.

The spine 2 has a first thickness T1 and a second thickness T2. As illustrated for reference purposes, the spine 2 has a central axis CA. A first distal region 14a extends from the first longitudinal edge 10a of the spine 2 (i.e., distal end of spine 2 with respect to central axis CA) to a terminus point TP of the first distal region 14a. A second distal region 14b extends from the second longitudinal edge 10b of the spine 2 (i.e., distal end of spine 2 with respect to central axis CA) to a terminus point TP of the second distal region 14b. The first distal region 14a and the second distal region 114b have the first thickness T1. The first thickness T1 has a thickness range between about 2.5 millimeters and about 3.5 millimeters. The spine thickness decreases from the terminus point TP of the first distal region 14a to a central region 16 of the spine 2 forming a first transitional region 15a. Also, the spine thickness decreases from the terminus point TP of the second distal region 14b to the central region 16 of the spine 2 forming a second transitional region 15b. The central region 16 has the second thickness T2. The second thickness T2 has a thickness range between about 0.5 millimeter and about 2 millimeters. Thus, the first thickness T1 is generally greater than the second thickness T2. In one example embodiment, a ratio of the first thickness T1 to the second thickness T2 is between about 1.75 and about 5.

A relationship between a diameter DM of the marker 7 compared to a diameter D of the hollow region 20 allows for the spine 2/rewritable surface 5 combination to form the interference compression fit with the marker 7 in the closed position. The diameter D of the hollow region 20 (without the marker 7) is generally smaller than the diameter DM of the marker 7. The spine 2/rewritable surface 5 combination form the hollow region 20 having the characteristic of a tight volumetric space. This hollow region 20 is configured to particularly provide a snug fit around the marker 7 so that the marker 7 is locked in place (i.e., diameter D of hollow region 20 increases as spine 2/rewritable surface 5 combination bend to fit around the marker 7). The marker 7 is locked or tightly engaged within the hollow region 20. This snug fit provided by the hollow region 20 locks the marker 7 in place such that the rewritable tablet book 1 can be moved in any direction without the marker 7 disengaging from the hollow region 20. The marker 7 generally has a diameter DM range between about 13 millimeters and about 17 millimeters. When in the closed position, the hollow region 20 has a diameter D range between about 12 millimeters and about 14 millimeters without holding the marker 7. The diameter D range of the hollow region 20 expands to the diameter DM range of the marker 7 by the spine 2/rewritable surface 5 combination flexing to fit around the marker 7. The spine 2/rewritable surface 5 combination can bend or flex further (i.e., further increase the diameter D range of the hollow region 20) to fit around the marker 7 wrapped in the eraser cloth 6. This relationship between the diameter DM range of the marker 7 to the diameter D range of the hollow region 20 (without holding the marker 7) can be represented as a ratio. For example, this ratio (diameter DM of marker 7 to diameter D of hollow region 20) has a range between about 1.083 and about 1.214.

As illustrated in FIG. 3B, the spine 2/rewritable surface 5 combination can additionally grip the marker 7 wrapped within the eraser cloth 6. The gripping functionality is improved in this embodiment due to the eraser cloth 6 providing additional friction with the rewritable surface 5 so that the marker 7 and eraser cloth 6 stay within the rewritable tablet book 1. The combination of the front cover 4a, back cover 4b, spine 2, rewritable surface 5, and fastener 3 provide sufficient force to close the rewritable tablet book 1 (i.e., closed position). In this closed position, the marker 7 wrapped within the eraser cloth 6 is gripped and fixed in place within the hollow region 20 formed by the spine 2/rewritable surface 5 combination.

The spine 2 and fastener 3 provide the main forces used to grasp the marker 7 and maintain the closed position or open position. The spine 2 provides the functionality of holding the marker 7 in place by a friction fit inside the curvature of the hollow region 20 formed by the spine 2/rewritable surface 5 combination. The spine 2 is bound to the front cover 4a and back cover 4b in such a way that closing the rewritable tablet book 1 stretches the spine 2 and puts it under tension. This tension provides a force towards closing or opening the rewritable tablet book 1. In the illustrated example, the fastener 3 (i.e., closure band) has sufficient resilience for wrapping around the outer edge of the closed rewritable tablet book 1 but enough strength to counteract the tension of the spine 2 helping to maintain the closed position.

In one example, when the eraser cloth 6 and marker 7 are flexibly held in place inside the rewritable tablet book 1, stability of the rewritable tablet book 1 is increased such that a reasonable force of compression can be applied to the cover 4a, 4b without significantly damaging the rewritable surface 5.

In example embodiments, there are preferred ratios of thicknesses between different components. These ratios provide flexible, elastic, and resilient properties that allow for the rewritable tablet book 1 to grasp the marker 7 in the closed position. Also, these ratios provide flexible, elastic, and resilient properties that enable the rewritable tablet book 1 to spring open when the fastener 3 is released from the rewritable tablet book 1 (i.e., transition from closed position to open position). In one example, the ratio of the rewritable surface thickness to the cover (front or back 4a, 4b) thickness is between about 0.07 and about 0.1. In another example, the ratio of the cover (front or back 4a, 4b) thickness to the spine thickness is between about 1.43 and about 4.

In another example, as illustrated in FIG. 3C, the spine 2/rewritable surface 5 combination can grip the marker 7 surrounded by at least one o-ring 24 in the closed position. The o-ring 24 provides a buffer between the marker 7 and the spine 2/rewritable surface 5 combination. In particular, the spine 2/rewritable surface 5 combination frictionally grips the o-ring 24 surrounding the marker 7 such that the marker 7 is held within the hollow region 20. Further, a coefficient of friction between the o-ring 24 of the marker 7 and the rewritable surface 5 allows for the marker 7 to be held in the hollow region 20. As shown in FIG. 5, the marker can be surrounded by two o-rings 24A, 24B. In this example, a first o-ring 24A is positioned near the writing end or cap section of the marker 7 and a second o-ring 24B is positioned near the rear end (i.e., opposite end from writing end) of the marker 7. With two o-rings 24A, 24B, the marker 7 is held within the hollow region 20 such that the spine 2/rewritable surface 5 combination frictionally grips the first o-ring 24A at one end and frictionally grips the second o-ring 24B at an opposite end of the rewritable tablet book 1. The o-ring 24 can also function as an eraser for removing writing from the rewritable surface 5. In one example, the o-ring 24 is made from a rubber material. The o-ring 24 may be comprised of other materials as appreciated by one of skill in the art. In one example, the o-rings 24A, 24B are separate elements inserted along a body of the marker 7. In another example, the o-rings 24A, 24B are integrated with the body of the marker 7. For example, the marker 7 is fabricated with at least one custom-fit o-ring section 24 near the cap section of the marker 7 and/or at least one custom-fit o-ring section 24 near the rear end of the marker 7.

FIG. 4 illustrates the rewritable tablet book 1 in the open position according to an embodiment of the present invention.

When the rewritable tablet book 1 is opened, the rewritable surface 5 provides a rewritable space for drawing or writing with the marker 7. As shown in FIG. 4, the rewritable surface 5 extends across an inside surface of the covers 4a, 4b. In particular, the rewritable surface 5 is part of a rewritable sheet that is mounted to the inside surface of the covers 4a, 4b in a centered position with a narrow margin to the edge of the construction. The rewritable surface 5 can be opaque or transparent. In one example, the rewritable surface 5 can bear permanent markings, such as templates for particular writing applications. In other examples, the rewritable surface 5 is bright white, glow-in-the-dark, or another color conducive to a particular writing application of the rewritable tablet book 1 as appreciated by one of skill in the art. The re-writable surface 5 has a thickness such that it can bend when the rewritable tablet book 1 is closed but can also resist creasing. In particular, the rewritable surface 5 is designed such that it can bend within the spine 2 without creasing.

In operation, the rewritable tablet book 1 transitions from the closed positions of FIGS. 1-3C to the open position of FIG. 4 when the fastener 3 is released from the covers 4a, 4b. This causes the covers 4a, 4b to spring open such that the rewritable surface 5 transitions into a flat surface. This force is caused by a release of tension from the spine 2 and the natural memory of the rewritable surface 5 mounted to the inside surface of the front cover 4a, back cover 4b, and spine 2. The weight of the front cover 4a and back cover 4b aid in maintaining this open position. In this open position, the rewritable tablet book 1 can be placed flat on a table. Further, the flat rewritable surface 5 of the rewritable sheet is revealed which can receive writing from the marker 7.

FIG 5. illustrates an example eraser cloth 6, the marker 7, and the marker 7 having o-rings 24A, 24B. This example illustrates a comparison of the eraser cloth size to the marker size such that the marker 7 can be wrapped within the eraser cloth 6. The marker 7 wrapped in the eraser cloth 6 can be stored in the rewritable tablet book 1 in the closed position as shown in FIG. 3B. The marker 7 having o-rings 24A, 24B can also be wrapped in the eraser cloth 6 and stored in the rewritable tablet book 1 similar to FIG. 3B.

The marker 7 is illustrated as a dry erase marker. However, depending on the material of the rewritable surface 5, the marker 7 can alternatively be another type of marker such as a chalk marker for a blackboard or an electronic marker for e-paper. The marker 7 can vary in diameter DM such that the marker 7 can be gripped within the rewritable tablet book 1 in the closed position.

The eraser cloth 6 is constructed from a soft fabric material such as polar fleece, cotton, wool, polyester, microfiber, or the like. As shown in FIG. 5, the eraser cloth 6 has a length or width dimension which at least exceeds the length of the marker 7. The eraser cloth 6 is of a thickness and softness for flexibly holding the marker 7 inside the curvature (i.e., hollow region 20) of the spine 2/rewritable surface 5 combination as described above. In a preferred example, before the rewritable tablet book 1 is held closed by the fastener 3, the eraser cloth 6 is placed between the rewritable surface 5 and the marker 7 such that the eraser cloth 6 is oriented to be aligned with the marker 7. This orientation prevents both ends of the marker 7 from making any contact with the rewritable surface 5 of the rewritable sheet which prevents scratching of the rewritable surface 5. In example embodiments, the eraser cloth 6 has a thickness range between about 1 millimeter and about 5 millimeters.

In example embodiments, the main components (front cover 4a, back cover 4b, and spine 2) of the rewritable tablet book 1 can be constructed from a unitary sheet. This unitary sheet is formed into the rewritable tablet book unit 1 having the flexible, elastic, and resilient properties described above. An example unitary sheet material can include rubber such as neoprene or the like. The rewritable tablet book 1 can be formed from the unitary sheet material (e.g., neoprene) by applying a molding process such as injection molding. In one example, the front cover 4a, the back cover 4b, and/or the spine 2 are independently formed from the unitary sheet using multiple injection molding processes. In this example, the separately molded components of the front cover 4a, the back cover 4b, and the spine 2 are constructed together with the rewritable surface 5 to produce the rewritable tablet book 1. In another example, the front cover 4a, the back cover 4b, and the spine 2 are formed together from the unitary sheet during multiple stages of a single injection molding process. The rewritable surface 5 is either mounted to an inside surface of the molded unitary sheet or the rewritable surface 5 is created by coating plastic mounted to the inside surface of the molded unitary sheet.

While this invention has been particularly shown and described with references to preferred embodiments thereof, it will be understood by those skilled in the art that various changes in form and details may be made therein without departing from the scope of the invention encompassed by the appended claims.

What is claimed is:

1. A rewritable tablet book, comprising:
a front cover;
a back cover;
a spine for connecting the back cover to the front cover;
a rewritable surface extending across an inside surface of the front cover, the spine, and the back cover; and
a fastener;
wherein the fastener joins the front cover to the back cover in a closed position to hold a marker in a hollow region defined by the rewritable surface and the spine.

2. The rewritable tablet book according to claim 1, wherein the spine is constructed from an elastic material.

3. The rewritable tablet book according to claim 2, wherein the elastic material is rubber.

4. The rewritable tablet book according to claim 1, wherein the fastener is a closure band, a clip, a magnet, a string tie, a snap, a clasp, a rivet, or a pin for joining or disjoining the front cover to or from the back cover.

5. The rewritable tablet book according to claim 1, wherein the hollow region holds the marker wrapped in an eraser cloth.

6. The rewritable tablet book according to claim 1, wherein the front cover back cover are constructed from a cardboard material.

7. The rewritable tablet book according to claim 1, wherein the front cover and back cover each have a thickness range between about 2 millimeters and about 5 millimeters.

8. The rewritable tablet book according to claim 1, wherein the rewritable surface is constructed of a plastic material.

9. The rewritable tablet book according to claim 1, wherein the rewritable surface is opaque or transparent.

10. The rewritable tablet book according to claim 1, wherein the hollow region has a diameter range between about 12 millimeters and about 14 millimeters in the closed position.

11. The rewritable tablet book according to claim 1, wherein the front cover, the back cover, and the spine are constructed from a unitary sheet.

12. The rewritable tablet book according to claim 1, wherein the spine comprises at least two different thicknesses.

13. The rewritable tablet book according to claim 12, wherein the spine comprises:
a distal region extending from an edge of the spine to a terminus point of the distal region, the distal region has a first thickness;
a transitional region extending from the terminus point of the distal region; and
a central region extending from the transitional region, the central region has a second thickness;
wherein the spine thickness of the transitional region decreases from the terminus point of the distal region to the central region such that the first thickness is greater than the second thickness.

14. A rewritable tablet book kit, comprising:
a front cover;
a back cover;
a spine for connecting the back cover to the front cover;
a rewritable surface extending across an inside surface of the front cover, the spine, and the back cover;
a fastener; and
a marker for writing on the rewritable surface;
wherein the fastener joins the front cover to the back cover in a closed position to hold the marker in a hollow region defined by the rewritable surface and the spine.

15. The kit according to claim 14, further comprising an eraser cloth for erasing writing from the rewritable surface, wherein the eraser cloth is wrapped around the marker and held in the hollow region defined by the rewritable surface and the spine in the closed position.

16. The kit according to claim 15, wherein the eraser cloth is constructed from polar fleece, cotton, wool, polyester, or microfiber.

17. The kit according to claim 14. wherein the marker has a diameter range between about 13 millimeters and about 17 millimeters.

18. The kit according to claim 14, wherein the spine comprises at least two different thicknesses.

19. A method for storing a marker in a rewritable tablet book, comprising:
the rewritable tablet book having a front cover, a back cover, a spine, and a rewritable surface extending across an inside surface of the front cover, the spine, and the back cover;
a fastener joining the front cover to the back cover in a closed position; and
the rewritable surface holding a marker in a hollow region defined by the rewritable surface and the spine in the closed position.

20. The method according to claim 19, further comprising wrapping an eraser cloth around the marker, wherein the rewritable surface holds the marker wrapped in the eraser cloth in the hollow region defined by the rewritable surface and the spine in the closed position.
